(19) United States
(12) Patent Application Publication
(10) Pub. No.: US 2024/0295790 A1
(43) Pub. Date: Sep. 5, 2024

(54) ELECTRONIC PAPER DISPLAY DEVICE

(71) Applicant: E Ink Holdings Inc., HSINCHU (TW)

(72) Inventors: Ming-Huan YANG, HSINCHU (TW); Yi-Sheng LIN, HSINCHU (TW); Yi-Shou TSAI, HSINCHU (TW); Chen-Chu TSAI, HSINCHU (TW)

(21) Appl. No.: 18/592,483

(22) Filed: Feb. 29, 2024

(30) Foreign Application Priority Data
Mar. 1, 2023 (TW) 112107227

(51) Int. Cl. G02F 1/16755; G02F 1/167

(52) U.S. Cl. CPC G02F 1/16755; G02F 1/167

(57) ABSTRACT

An electronic paper display device includes a frame, an upper protective layer, a lower protective layer, a flexible substrate, a reinforcing layer, and a front panel. The upper protective layer and the lower protective layer are respectively located on a top surface and a bottom surface of the frame. The flexible substrate extends from the upper protective layer to the lower protective layer. The flexible substrate has a first area located on the upper protective layer, a second area located on the lower protective layer, a bending area, and two non-deformed areas. One of the two non-deformed areas is located between the first area and the bending area, and another one of the two non-deformed areas is located between the second area and the bending area. The reinforcing layer is located on the flexible substrate. The front panel is located on the first area.

### RELATED APPLICATIONS

This application claims priority to Taiwan Application Serial Number 112107227, filed Mar. 1, 2023, which is herein incorporated by reference.

### BACKGROUND

### Field of Invention

The present disclosure relates to an electronic paper display device.

### Description of Related Art

Flexible display panels had been widely used as display screens in various consumer electronic products nowadays. The frame of a flexible display panel may be narrowed by the pad bending process in the chip on plastic (COP) packaging to achieve the design of the narrow bezel panel. In general, due to the concentrated bending stress in the bending area of the flexible display panel, metal lines on the bending region are prone to fracture, resulting in a lower yield rate for the COP packaging process.

In traditional structural design, reinforcing materials may be coated on the bending area of the flexible display panel to compensate the bending stress. However, since the bending stress also concentrates between the bending area and the non-bending area, the metal lines in the flexible display panel with the reinforcing materials may still break.

### SUMMARY

One aspect of the present disclosure provides an electronic paper display device.

According to some embodiments of the present disclosure, an electronic paper display device includes a frame, an upper protective layer, a lower protective layer, a flexible substrate, a reinforcing layer, and a front panel. The upper protective layer is located on a top surface of the frame. The lower protective layer is located on a bottom surface of the frame. The flexible substrate extends from the upper protective layer to the lower protective layer. The flexible substrate has a first area located on the upper protective layer, a second area located on the lower protective layer, a bending area, and two non-deformed areas. One of the two non-deformed areas is located between the first area and the bending area, and the other one of the two non-deformed areas is located between the second area and the bending area. The reinforcing layer is located on the first area, the second area, the bending area, and the two non-deformed areas of the flexible substrate. The front panel is located on the first area of the flexible substrate.

In some embodiments, a width of each of the two non-deformed areas of the flexible substrate is less than or equal to a bend radius of the bending area.

In some embodiments, the two non-deformed areas of the flexible substrate respectively extend from the upper protective layer and the lower protective layer, such that the two non-deformed areas suspend in mid-air.

In some embodiments, the electronic paper display device further includes a chip located on the second area of the flexible substrate.

In some embodiments, two opposite edges of each of the two non-deformed areas of the flexible substrate adjoin the bending area and one of the first area and the second area.

In some embodiments, the two non-deformed areas of the flexible substrate overlap with each other in a vertical direction.

In some embodiments, the one of the two non-deformed areas does not overlap with the upper protective layer in a vertical direction, and the another one of the two non-deformed areas does not overlap with the lower protective layer in the vertical direction.

In some embodiments, the reinforcing layer has two strengthened areas, and the two strengthened areas respectively overlap with the two non-deformed areas of the flexible substrate.

In some embodiments, a sidewall of the frame, a sidewall of the upper protective layer, and a sidewall of the lower protective layer are aligned with each other in a vertical direction.

In some embodiments, a sidewall of the frame is recessed from a sidewall of the upper protective layer and a sidewall of the lower protective layer.

In some embodiments, a sidewall of the frame protrudes from a sidewall of the upper protective layer and a sidewall of the lower protective layer.

In some embodiments, the frame protruding from the sidewall of the upper protective layer and the sidewall of the lower protective layer overlaps with each of the two non-deformed areas of the flexible substrate.

In some embodiments, the front panel comprises a front protective sheet, a display medium layer located between the front protective sheet and the first area of the flexible substrate, and a function layer located on the front protective sheet.

Another aspect of the present disclosure provides an electronic paper display device.

According to some embodiments of the present disclosure, an electronic paper display device includes a frame, an upper protective layer, a lower protective layer, a flexible substrate, a reinforcing layer, and a front panel. The upper protective layer is located on a top surface of the frame. The lower protective layer is located on a bottom surface of the frame. The flexible substrate extends from the upper protective layer to the lower protective layer. The flexible substrate has a first area located on the upper protective layer, a second area located on the lower protective layer, a bending area, and two non-deformed areas. The two non-deformed areas respectively extend from the upper protective layer and the lower protective layer. Two edges of the two non-deformed areas away from the first area and the second area adjoin the bending area. The reinforcing layer is located on the first area, the second area, the bending area, and the two non-deformed areas of the flexible substrate. The front panel is located on the first area of the flexible substrate.

In some embodiments, the electronic paper display device further includes a chip and a flexible circuit board. The chip is located on the second area of the flexible substrate. The flexible circuit board is located on the second area of the flexible substrate. The flexible circuit board is electrically connected to the chip.

In some embodiments, a width of each of the two non-deformed areas of the flexible substrate is less than or equal to a bend radius of the bending area.

In some embodiments, the two non-deformed areas of the flexible substrate overlap with each other in a vertical direction.

In some embodiments, a sidewall of the upper protective layer, a sidewall of the frame, and a sidewall of the lower protective layer define a vertical plane, a recess structure, or a protruding structure.

In the aforementioned embodiments of the present disclosure, since the electronic paper display device has the two non-deformed areas, one of the two non-deformed areas is located between the first area and the bending area, and the other one of the two non-deformed areas is located between the second area and the bending area, the bending stress may be avoid from concentrating on the edge of the first area and the edge of the second area, and be confined in the bending area, which may prevent the metal lines on the edges of the first and second areas from fracture, thereby improving the yield rate for the pad bending process in the chip on plastic (COP) packaging. In other words, the region where the structural thickness of the electronic paper display device varies have no bending stress, and hence the breakage of the metal lines and the resulting circuit interruption may be prevented, thereby enhancing the yield rate for the pad bending process used to achieve narrow bezel panels.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of an electronic paper display device according to one embodiment of the present disclosure.

FIG. 2 is a cross-sectional view of an electronic paper display device according to another embodiment of the present disclosure.

FIG. 3 is a cross-sectional view of an electronic paper display device according to yet another embodiment of the present disclosure.

FIG. 4 is a cross-sectional view of an electronic paper display device according to still another embodiment of the present disclosure.

FIG. 5 is a cross-sectional view of an electronic paper display device according to one embodiment of the present disclosure.

FIG. 6 is a cross-sectional view of an electronic paper display device according to another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

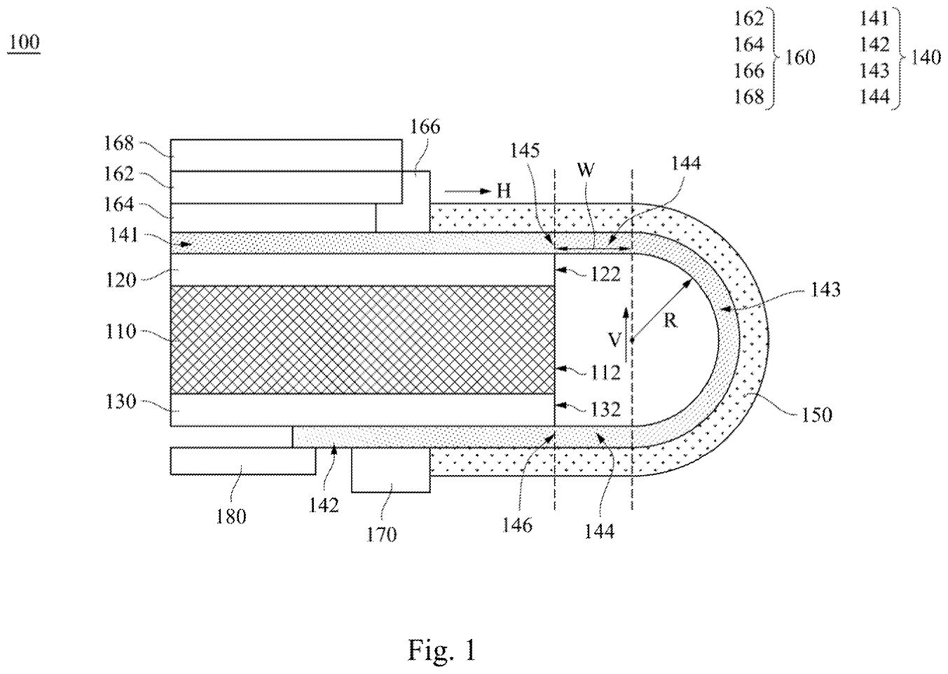

FIG. 1 is a cross-sectional view of an electronic paper display device 100 according to one embodiment of the present disclosure. The electronic paper display device 100 includes a frame 110, an upper protective layer 120, a lower protective layer 130, a flexible substrate 140, a reinforcing layer 150, and a front panel 160. The upper protective layer 120 is located on a top surface of the frame 110. The lower protective layer 130 is located on a bottom surface of the frame 110. The flexible substrate 140 extends from the upper protective layer 120 to the lower protective layer 130. The flexible substrate 140 has a first area 141 located on the upper protective layer 120, a second area 142 located on the lower protective layer 130, a bending area 143, and two non-deformed areas 144. One of the two non-deformed areas 144 (such as the upper one of the two non-deformed areas 144) is located between the first area 141 and the bending area 143, and the other one of the two non-deformed areas 144 (such as the lower one of the two non-deformed areas 144) is located between the second area 142 and the bending area 143. The reinforcing layer 150 is located on the first area 141, the second area 142, the bending area 143, and the two non-deformed areas 144 of the flexible substrate 140, so that the flexible substrate 140 may withstand higher bending stress. The front panel 160 is located on the first area 141 of the flexible substrate 140. In addition, the bending area 143 of the flexible substrate 140 has a bend radius R and a bending axis located on the interface plane between the bending area 143 and each of the two non-deformed areas 144, and hence the two non-deformed areas 144 may be defined as two areas which respectively extends from the first area 141 and the second area 142 of the flexible substrate 140 to the interface plane. In some embodiments, the electronic paper display device 100 further includes a chip 170 located on the second area 142 of the flexible substrate 140. The front panel 160 may be electrically connected to the chip 170 by the metal lines on the flexible substrate 140.

Specifically, since the flexible substrate 140 of the electronic paper display device 100 has the two non-deformed areas 144, one of the two non-deformed areas 144 is located between the first area 141 and the bending area 143, and the other one of the two non-deformed areas 144 is located between the second area 142 and the bending area 143, the bending stress may be avoid from concentrating on the edge 145 of the first area 141 facing toward the bending area 143 and the edge 146 of the second area 142 facing toward the bending area 143 (in which the edge 145 and the edge 146 are where the structural thickness of the electronic paper display device 100 varies), and be confined in the bending area 143, which may prevent the metal lines on the edge 145 of the first area 141 and the edge 146 of the second area 142 from fracture, thereby improving the yield rate for the pad bending process in the chip on plastic (COP) packaging. In other words, the edge 145 of the first area 141 and the edge 146 of the second area 142, where the structural thickness of the electronic paper display device 100 varies, have no bending stress, and hence the breakage of the metal lines on the flexible substrate 140 and the resulting circuit interruption may be prevented, thereby enhancing the yield rate for the pad bending process used to achieve narrow bezel panels.

In some embodiments, the front panel 160 of the electronic paper display device 100 may be a front panel laminate. The front panel 160 includes a front protective sheet 162, a display medium layer 164 located under the front protective sheet 162, an adhesive layer 166 enclosing the display medium layer 164, and a function layer 168 located on the front protective sheet 162. An electrode layer (common electrode) may be disposed on the bottom surface of the front protective sheet 162, and the electrode layer may be a transparent conductive film. The material of the transparent conductive film may include indium tin oxide (ITO). The display medium layer 164 may be electronic ink layer. The material of the adhesive layer 166 may include epoxy resin. The adhesive layer 166 may act as a sealant to seal the display medium layer 164 between the front protective sheet 162 and the flexible substrate 140. The function layer 168 may be a touch sensing layer so that the electronic paper display device 100 has a touch function. Alternatively, the function layer 168 may be anti-reflective (AR) layer to decline the reflection of the light by the electronic paper display device 100, thereby improving the image quality.

Moreover, the portion of the first area 141 of the flexible substrate 140 which overlaps with the display medium layer 164 may have a thin film transistor (TFT) array acting as a pixel electrode. The first area 141 of the flexible substrate 140 may be electrically connected to the chip 170 by the metal lines on the flexible substrate 140 to drive the display medium layer 164 and therefore achieve the function of displaying images. In some embodiments, the material of the flexible substrate 140 may include polyimide (PI) and the chip 170 may be a driver chip, but the present disclosure is not limited in this regard.

In some embodiments, a width W of each of the two non-deformed areas 144 of the flexible substrate 140 may be less than or equal to the bend radius R of the bending area 143. For example, the width W of each of the two non-deformed areas 144 of the flexible substrate 140 may be equal to the bend radius R of the bending area 143. Such a configuration may ensure the width W of each of the two non-deformed areas 144 is long enough to prevent the metal lines on the edge 145 of the first area 141 and the edge 146 of the second area 142 from breaking by the bending stress. In addition, the two non-deformed areas 144 of the flexible substrate 140 respectively extend from the upper protective layer 120 and the lower protective layer 130, such that the two non-deformed areas 144 suspend in mid-air. In this embodiment, the two non-deformed areas 144 do not overlap with each of the upper protective layer 120 and the lower protective layer 130 in a vertical direction. That is to say, the two non-deformed areas 144 are located nearby the position having the structural thickness variation of the electronic paper display device 100, and act as a buffer region to avoid the bending stress from concentrating at the aforementioned position and causing damage to the electronic paper display device 100.

In addition, as shown in FIG. 1, two opposite edges of the upper one of the two non-deformed areas 144 of the flexible substrate 140 respectively adjoin the first area 141 and the bending area 143, and two opposite edges of the lower one of the two non-deformed areas 144 of the flexible substrate 140 respectively adjoin the second area 142 and the bending area 143. That is to say, the two edges of the two non-deformed areas 144 respectively away from the first area 141 and the second area 142 adjoin the bending area 143. In some embodiments, the two non-deformed areas 144 overlap with each other in a vertical direction V. In such a configuration, the electronic paper display device 100 may not only avoid the bending stress from concentrating at the edge 145 of the first area 141 and the edge 146 of the second area 142, but also be applied to achieve a narrow bezel panel. In some embodiments, the electronic paper display device 100 may further include a flexible circuit board 180. The flexible circuit board 180 is located on the second area 142 of the flexible substrate 140. The flexible circuit board 180 may be electrically connected to the front panel 160 and the chip 170 by the metal lines.

In this embodiment, a sidewall 112 of the frame 110, a sidewall 122 of the upper protective layer 120, and a sidewall 132 of the lower protective layer 130 are aligned with each other in the vertical direction V, so that the sidewall 122 of the upper protective layer 120, the sidewall 112 of the frame 110, and the sidewall 132 of the lower protective layer 130 may define a vertical plane. Such a configuration implies that there is no alignment error between the frame 110, the upper protective layer 120, and the lower protective layer 130.

It is to be noted that the connection relationships, the materials, and the advantages of the elements described above will not be repeated in the following description. In the following description, other types of the electronic paper display devices will be described.

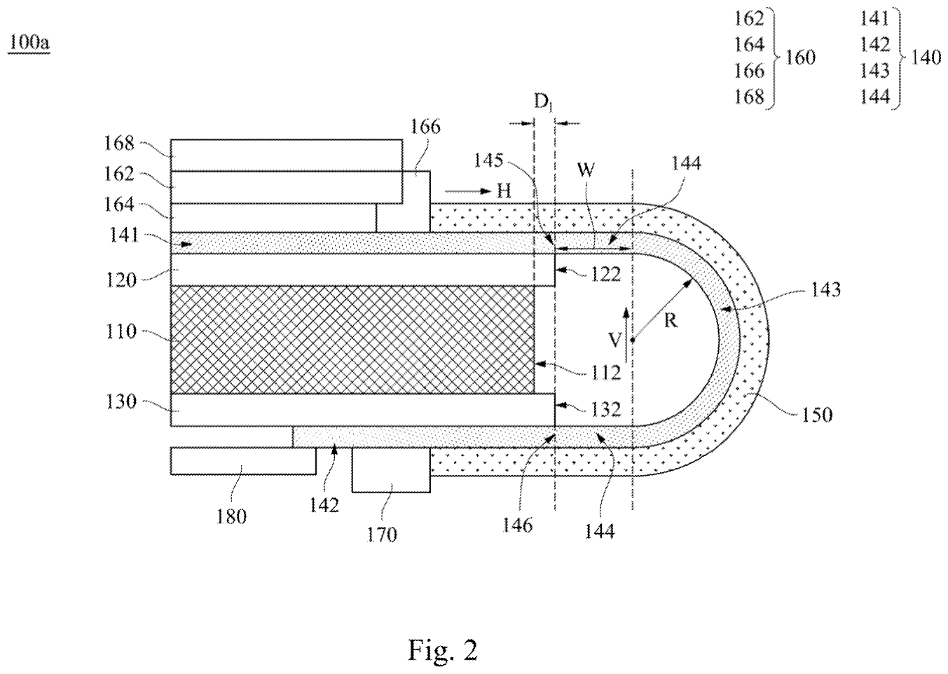

FIG. 2 is a cross-sectional view of an electronic paper display device 100a according to another embodiment of the present disclosure. The electronic paper display device 100a includes the frame 110, the upper protective layer 120, the lower protective layer 130, the flexible substrate 140, the reinforcing layer 150, the front panel 160, and the chip 170. The difference between this embodiment and the embodiment of FIG. 1 is that the sidewall 112 of the frame 110 of the electronic paper display device 100a is recessed from the sidewall 122 of the upper protective layer 120 and the sidewall 132 of the lower protective layer 130, so that the sidewall 122 of the upper protective layer 120, the sidewall 112 of the frame 110, and the sidewall 132 of the lower protective layer 130 of the electronic paper display device 100a may define a recess structure. In some embodiments, a distance D1 between the sidewall 112 of the frame 110 and each one of the sidewall 122 of the upper protective layer 120 and the sidewall 132 of the lower protective layer 130 along a horizontal direction H is less than or equal to 0.2 mm. Such a configuration implied that there is an alignment error between the frame 110 of the electronic paper display device 100a and the upper protective layer 120, and between the frame 110 of the electronic paper display device 100a and the lower protective layer 130. However, the two non-deformed areas 144 the electronic paper display device 100a may still prevent the metal lines on the edge 145 of the first area 141 and the edge 146 of the second area 142 from fracture, and improve the yield rate for the pad bending process in the COP packaging.

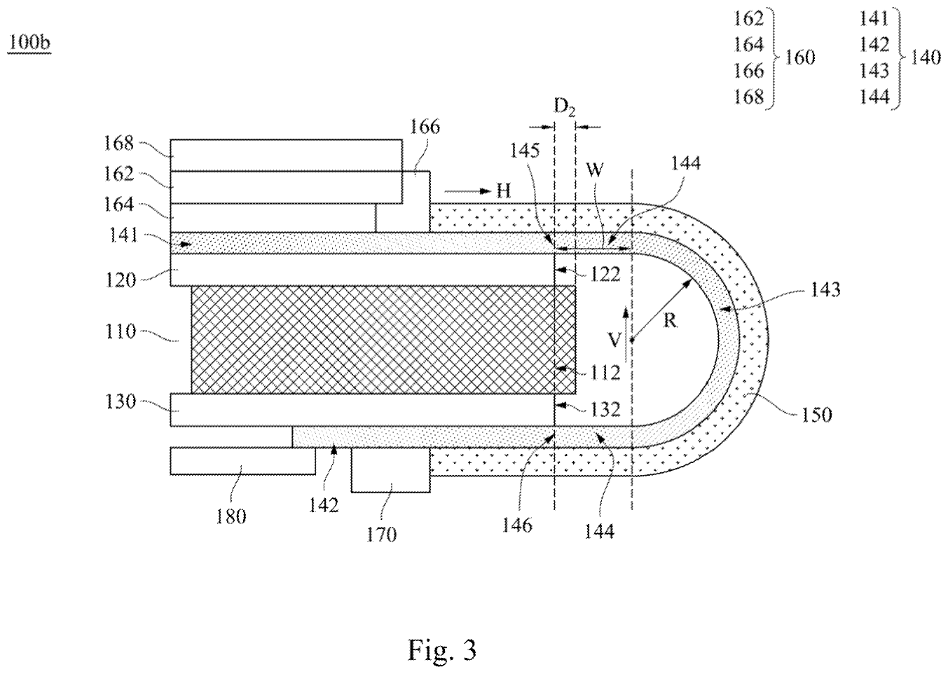

FIG. 3 is a cross-sectional view of an electronic paper display device 100b according to yet another embodiment of the present disclosure. The electronic paper display device 100b includes the frame 110, the upper protective layer 120, the lower protective layer 130, the flexible substrate 140, the reinforcing layer 150, the front panel 160, and the chip 170. The difference between this embodiment and the embodiment of FIG. 1 is that the sidewall 112 of the frame 110 of the electronic paper display device 100a protrudes from the sidewall 122 of the upper protective layer 120 and the sidewall 132 of the lower protective layer 130, so that the sidewall 122 of the upper protective layer 120, the sidewall 112 of the frame 110, and the sidewall 132 of the lower protective layer 130 of the electronic paper display device 100a may define a protruding structure. In addition, the frame 110 of the electronic paper display device 100a overlaps with each of the two non-deformed areas 144 in the vertical direction V. In some embodiments, a distance D2 between the sidewall 112 of the frame 110 and each one of the sidewall 122 of the upper protective layer 120 and the sidewall 132 of the lower protective layer 130 along a horizontal direction H is less than or equal to 0.2 mm. Such a configuration implied that there is an alignment error between the frame 110 of the electronic paper display device 100b and the upper protective layer 120, and between the frame 110 of the electronic paper display device 100b and the lower protective layer 130. However, the two non-deformed areas 144 of the electronic paper display device 100b may still prevent the metal lines on the edge 145 of the first area 141 and the edge 146 of the second area 142 from fracture, and improve the yield rate for the pad bending process in the COP packaging.

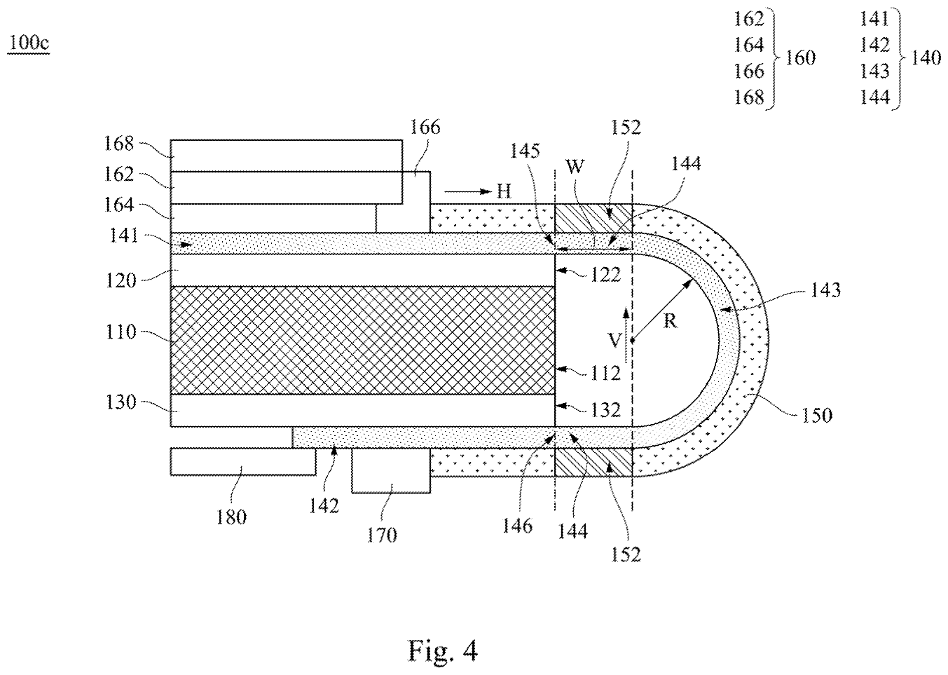

FIG. 4 is a cross-sectional view of an electronic paper display device 100c according to still another embodiment of the present disclosure. The electronic paper display device 100c includes the frame 110, the upper protective layer 120, the lower protective layer 130, the flexible substrate 140, the reinforcing layer 150, the front panel 160, and the chip 170. The difference between this embodiment and the embodiment of FIG. 1 is that the reinforcing layer 150 of the electronic paper display device 100c has two strengthened areas 152, and the two strengthened areas 152 respectively overlap with the two non-deformed areas 144 of the flexible substrate 140 in the vertical direction V. In this embodiment, a thermal treatment may be applied to the two strengthened areas 152 to enhance the hardness of the two strengthened areas 152, so that the two non-deformed areas 144 of the flexible substrate 140 under the two strengthened areas 152 may withstand higher bending stress. In some embodiments, the material of the reinforcing layer 150 may include an organic material such as a soft plastic material (e.g., polyethylene terephthalate (PET), polyethylene naphthalate (PEN), and the like). In addition, the thickness of the reinforcing layer 150 may be adapted to the actual design requirements according to Young's modulus.

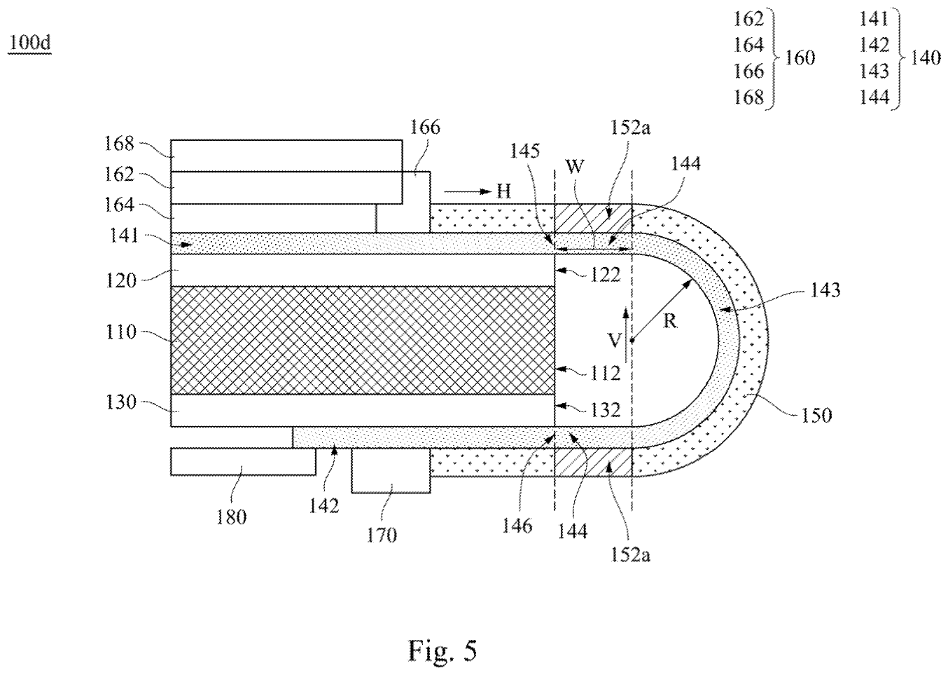

FIG. 5 is a cross-sectional view of an electronic paper display device 100d according to one embodiment of the present disclosure. The electronic paper display device 100d includes the frame 110, the upper protective layer 120, the lower protective layer 130, the flexible substrate 140, the reinforcing layer 150, the front panel 160, and the chip 170. The difference between this embodiment and the embodiment of FIG. 4 is that the hardness of the two strengthened areas 152a of the reinforcing layer 150 of the electronic paper display device 100d is enhanced by irradiating ultraviolet light not applying the thermal treatment the two strengthened areas 152a. As a result, the two non-deformed areas 144 of the flexible substrate 140 under the two strengthened areas 152a may withstand higher bending stress.

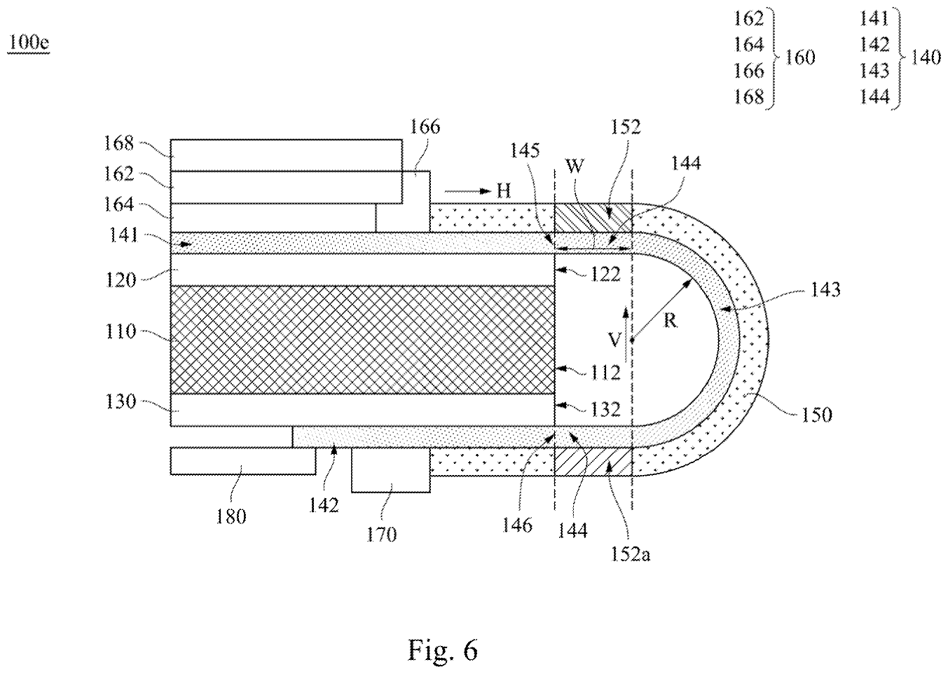

FIG. 6 is a cross-sectional view of an electronic paper display device 100e according to another embodiment of the present disclosure. The electronic paper display device 100e includes the frame 110, the upper protective layer 120, the lower protective layer 130, the flexible substrate 140, the reinforcing layer 150, the front panel 160, and the chip 170. The difference between this embodiment, the embodiment of FIG. 4, and the embodiment of FIG. 5 is that the reinforcing layer 150 has the strengthened area 152 and the strengthened area 152a simultaneously. For example, the hardness of the strengthened areas 152 is enhanced by applying the thermal treatment to the strengthened areas 152, and the hardness of the strengthened areas 152a is enhanced by irradiating ultraviolet light to the strengthened areas 152a.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An electronic paper display device, comprising:
a frame;
an upper protective layer located on a top surface of the frame;
a lower protective layer located on a bottom surface of the frame;
a flexible substrate extending from the upper protective layer to the lower protective layer and having a first area located on the upper protective layer, a second area located on the lower protective layer, a bending area, and two non-deformed areas, wherein one of the two non-deformed areas is located between the first area and the bending area, and another one of the two non-deformed areas is located between the second area and the bending area;
a reinforcing layer located on the first area, the second area, the bending area, and the two non-deformed areas of the flexible substrate; and
a front panel located on the first area of the flexible substrate.

2. The electronic paper display device of claim 1, wherein a width of each of the two non-deformed areas of the flexible substrate is less than or equal to a bend radius of the bending area.

3. The electronic paper display device of claim 1, wherein the two non-deformed areas of the flexible substrate respectively extend from the upper protective layer and the lower protective layer, such that the two non-deformed areas suspend in mid-air.

4. The electronic paper display device of claim 1, wherein two opposite edges of each of the two non-deformed areas of the flexible substrate adjoin the bending area and one of the first area and the second area.

5. The electronic paper display device of claim 1, wherein the two non-deformed areas of the flexible substrate overlap with each other in a vertical direction.

6. The electronic paper display device of claim 1, wherein the one of the two non-deformed areas does not overlap with the upper protective layer in a vertical direction, and the another one of the two non-deformed areas does not overlap with the lower protective layer in the vertical direction.

7. The electronic paper display device of claim 1, wherein the reinforcing layer has two strengthened areas, and the two strengthened areas respectively overlap with the two non-deformed areas of the flexible substrate.

8. The electronic paper display device of claim 1, wherein a sidewall of the frame, a sidewall of the upper protective layer and a sidewall of the lower protective layer are aligned with each other in a vertical direction.

9. The electronic paper display device of claim 1, wherein a sidewall of the frame is recessed from a sidewall of the upper protective layer and a sidewall of the lower protective layer.

10. The electronic paper display device of claim 1, wherein a sidewall of the frame protrudes from a sidewall of the upper protective layer and a sidewall of the lower protective layer.

11. The electronic paper display device of claim 10, wherein the frame protruding from the sidewall of the upper protective layer and the sidewall of the lower protective layer overlaps with each of the two non-deformed areas of the flexible substrate.

12. The electronic paper display device of claim 1, wherein the front panel comprises a front protective sheet, a display medium layer located between the front protective sheet and the first area of the flexible substrate, and a function layer located on the front protective sheet.

13. The electronic paper display device of claim 1, further comprising:
a chip located on the second area of the flexible substrate.

14. An electronic paper display device, comprising:
a frame;
an upper protective layer located on a top surface of the frame;
a lower protective layer located on a bottom surface of the frame;
a flexible substrate extending from the upper protective layer to the lower protective layer and having a first area located on the upper protective layer, a second area located on the lower protective layer, a bending area, and two non-deformed areas, wherein the two non-deformed areas respectively extend from the upper protective layer and the lower protective layer, and two edges of the two non-deformed areas respectively away from the first area and the second area adjoin the bending area;
a reinforcing layer located on the first area, the second area, the bending area, and the two non-deformed areas of the flexible substrate; and
a front panel located on the first area of the flexible substrate.

15. The electronic paper display device of claim 14, further comprising:
a chip located on the second area of the flexible substrate; and
a flexible circuit board located on the second area of the flexible substrate and electrically connected to the chip.

16. The electronic paper display device of claim 14, wherein a width of each of the two non-deformed areas of the flexible substrate is less than or equal to a bend radius of the bending area.

17. The electronic paper display device of claim 14, wherein the two non-deformed areas of the flexible substrate overlap with each other in a vertical direction.

18. The electronic paper display device of claim 14, wherein a sidewall of the upper protective layer, a sidewall of the frame, and a sidewall of the lower protective layer define a vertical plane, a recess structure, or a protruding structure.
